(19) United States
(12) Patent Application Publication
(10) Pub. No.: US 2011/0174520 A1
(43) Pub. Date: Jul. 21, 2011

(54) INSULATED ELECTRIC WIRE

(75) Inventors: Hideo Fukuda, Tokyo (JP); Minoru Saito, Tokyo (JP); Isao Tomomatsu, Tokyo (JP); Tsuneo Aoi, Tokyo (JP); Xiao Chuan Zhu, Shanghai (CN)

(73) Assignee: THE FURUKAWA ELECTRIC CO., LTD., Tokyo (JP)

(21) Appl. No.: 13/056,424

(22) PCT Filed: Jul. 29, 2008
(86) PCT No.: PCT/JP2008/063565

§ 371 Date: Apr. 7, 2011

(51) Int. Cl. H01B 7/00

(52) U.S. Cl. 174/120 AR; 174/120 SR

(57) ABSTRACT

Disclosed is an insulated electric wire having a conductor and one or more insulating layers covering the conductor, the insulated electric wire comprising a polyester-based resin composition which constitutes at least one layer of the insulating layers and comprises a polyester-based resin (A) containing a liquid crystal polymer in an amount of 5-25 parts by mass relative to 75-95 parts by mass of a polyester-based resin other than liquid crystal polymers.

### TECHNICAL FIELD

The present invention relates to an insulated electric wire.

### BACKGROUND ART

The construction of a transformer is prescribed by IEC (International Electrotechnical Communication) standards Pub. 950, etc. Namely, these standards provide that at least three insulating layers be formed between primary and secondary windings (an enamel film which covers a conductor of a winding is not authorized as an insulating layer) or that the thickness of an insulating layer be 0.4 mm or more. The standards also provide that the creepage distance between the primary and secondary windings, which varies depending on applied voltage, be 5 mm or more, that the transformer withstands a voltage of 3,000 V, applied between the primary and secondary sides, for a minute or more, and the like.

According to such standards, as a currently prevailing transformer, a construction illustrated in a cross-section view of FIG. 2 has been adopted. Referring to FIG. 2, an enameled primary winding 4 is wound around a bobbin 2 on a ferrite core 1 in a manner such that insulating barriers 3 for securing the creepage distance are arranged individually on the opposite sides of the peripheral surface of the bobbin. An insulating tape 5 is wound for at least three turns on the primary winding 4, additional insulating barriers 3 for securing the creepage distance are arranged on the insulating tape, and an enameled secondary winding 6 is then wound around the insulating tape.

In recent years, however, a transformer having a structure that includes neither an insulating barrier 3 nor an insulating tape layer 5, as shown in FIG. 1, has been used instead of the transformer having the sectional structure shown in FIG. 2. The transformer shown in FIG. 1 has advantages in that the overall size thereof can be reduced compared to the transformer having the structure shown in FIG. 2 and that an operation of winding the insulating tape can be omitted.

In manufacturing the transformer shown in FIG. 1, it is necessary, in consideration of the aforesaid IEC standards, that at least three insulating layers 4b (6b), 4c (6c), and 4d (6d) are formed on the outer peripheral surface on one or both of conductors 4a (6a) of the primary winding 4 and the secondary winding 6.

As such a winding, there is known a structure in which an insulating tape is first wound around a conductor to form a first insulating layer thereon, and is further wound to form second and third insulating layers in succession, so as to form three insulating layers that are separable from one another. In addition, there is known a winding structure in which fluororesin in place of an insulating tape is successively extrusion-coated around a conductor enameled with polyurethane to form three insulating layers in all (see, for example, Japanese Utility Model Laid-Open Publication No. Hei 3-56112).

In the above-mentioned case of winding an insulating tape, however, because winding the tape is an unavoidable operation, the efficiency of production is extremely low, and thus the cost of the electrical wire is conspicuously increased.

In addition, in the case of extruding fluororesin, there is an advantage in that the insulating layers have good heat resistance, because they are formed of fluororesin. However, there are problems in that, because of the high cost of the resin and the property that when it is pulled at a high shearing speed, the external appearance is deteriorated, it is difficult to increase the production speed, and the cost of the electric wire is increased as in the case of winding the insulating tape.

In attempts to solve such problems, a multilayer insulated electric wire is put to practical use and is manufactured by extruding a modified polyester resin, the crystallization of which has been controlled to inhibit a decrease in the molecular weight thereof, around a conductor to form first and second insulating layers, and extrusion-coating polyamide resin around the second insulating layer to form a third insulating layer (see, for example, U.S. Pat. No. 5,606,152 and Japanese Patent Laid-open Publication No. Hei 6-223634). Also, according to the recent trend toward the miniaturization of electrical/electronic devices, a multilayer insulated electric wire, which has increased heat resistance in consideration of the effect of heat generation on the devices and comprises an inner layer, formed by extrusion-coating polyethersulfone resin, and an outermost layer, formed by extrusion-coating polyamide resin, has been proposed (see, for example, Japanese Patent Laid-Open Publication No. Hei 10-134642).

However, when a transformer is attached to a device after coil winding to form a circuit, a conductor is exposed at the top of an electric wire drawn from the transformer and is subjected to post-soldering. For this reason, a multilayer insulated electric wire having good solderability is required.

In addition, because the soldered electric wire is then treated with, for example, varnish, high solvent resistance is required. However, there is still no electric wire satisfying all the requirements.

### DISCLOSURE

The present invention provides:

(1) An insulated electric wire having a conductor and one or more insulating layers covering the conductor, the insulated electric wire comprising a polyester-based resin composition which constitutes at least one layer of the insulating layers and comprises a polyester-based resin (A) containing a liquid crystal polymer in an amount of 5-25 parts by mass relative to 75-95 parts by mass of a polyester-based resin other than liquid crystal polymers;

(2) The insulated electric wire as set forth in the item (1), wherein the polyester-based resin composition comprises a thermoplastic elastomer (B) and is a resin dispersion which contains, as a continuous phase, the polyester-based resin (A), and as a dispersed phase, the thermoplastic elastomer (B);

(3) The insulated electric wire as set forth in the item (2), wherein the polyester-based resin composition contains the thermoplastic elastomer (B) in an amount of less than 15 parts by mass relative to 100 parts by mass of the polyester-based resin (A);

(4) The insulated electric wire as set forth in the item (2) or (3), wherein a resin (B-1) containing at least one functional group selected from the group consisting of an epoxy group, an oxazolyl group, an amino group and a maleic anhydride group is used as the thermoplastic elastomer (B);

(5) The insulated electric wire as set forth in the item (2) or (3), wherein a core-shell polymer (B-2) having a rubber-like core, obtained from acrylate, methacrylate or a mixture thereof, and an outer shell consisting of a vinyl homopolymer or copolymer, is used as the thermoplastic elastomer (B); and

(6) The insulated electric wire as set forth in the item (2) or (3), wherein an ethylene-based copolymer (B-3) having either carboxylic acid or a metal salt of dicarboxylic acid in the side chain thereof is used as the thermoplastic elastomer (B).

The above and other features and advantages of the present invention will become apparent from the following description with reference to the accompanying drawings.

### DESCRIPTION OF DRAWINGS

FIG. 1 is a cross-sectional view illustrating an example of a transformer having a structure in which three-layer insulating layers are used as windings.

FIG. 2 is a cross-sectional view showing an example of a transformer according to the prior art.

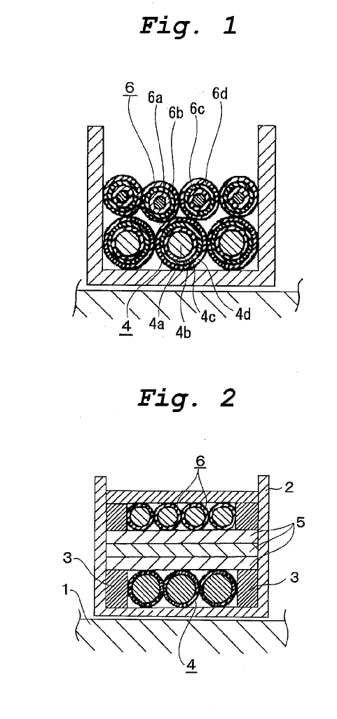

### BEST MODE

Materials which are used in the present invention will now be described.

(A) Polyester-Based Resin

The present invention utilizes a polyester-based resin composition constituting at least one insulating layer and comprising a polyester-based resin (A) which is obtained by blending a polyester-based resin other than liquid-crystal polymers with a given amount of a liquid-crystal polymer.

(Polyester Resin Other than Liquid-Crystal Polymers)

The polyester-based resin other than liquid-crystal polymers, which is used in the present invention, is preferably a resin obtained by esterification of either aromatic dicarboxylic acid or dicarboxylic acid, part of which is substituted with aliphatic dicarboxylic acid, with aliphatic diol. Typical examples thereof may include polyethylene terephthalate (PET), polybutylene terephthalate (PBT), polyethylene naphthalate (PEN) and the like.

Examples of the aromatic dicarboxylic acid that is used in the synthesis of the polyester-based resin include terephthalic acid, isophthalic acid, terephthalic dicarboxylic acid, diphenylsulfonedicarboxylic acid, diphenoxyethanedicarboxylic acid, diphenylethercarboxylic acid, methylterephthalic acid, methylisophthalic acid and the like. Among them, terephthalic acid is particularly preferred.

Examples of the aliphatic dicarboxylic acid that substitutes part of the aromatic dicarboxylic acid include succinic acid, adipic acid, sebacic acid and the like. The amount of substitution with the aliphatic dicarboxylic acid is preferably less than 30 mole %, and more preferably less than 20 mole %, based on the aromatic dicarboxylic acid. Meanwhile, examples of the aliphatic diol that is used in the esterification include ethylene glycol, trimethylene glycol, tetramethylene glycol, hexanediol, decanediol and the like. Among them, ethylene glycol and tetramethyl glycol are preferred. As part of the aliphatic diol, polyethylene glycol or polytetramethylene glycol may be used.

Commercially available polyethylene terephthalate resins, which can preferably used in the present invention, may include Byropet (trade name, manufactured by Toyobo Co., Ltd.), Bellpet (trade name, manufactured by Kanebo, Ltd.), and Teijin PET (trade name, manufactured by Teijin Ltd.). The polyethylene napthalate (PEN)-based resin may include Teijin PEN (trade name, manufactured by Teijin Ltd.), and the polycyclohexanedimethylene terephthalate (PCT)-based resins, may include EKTAR (trade name, manufactured by Toray Industries, Inc.).

(Liquid-Crystal Polymer)

The polyester-based resin (A) that is used in the present invention contains a liquid crystal polymer. The molecular structure, density, molecular weight of the liquid crystal polymer that is used in the present invention is not specifically limited, and preferred examples of the liquid crystal polymer are melt liquid-crystal type polymers (thermotropic liquid crystal polymers) which form liquid crystals when melted. The melt liquid-crystal type polymers are preferably melt liquid-crystal type polyester polymers.

Such melt liquid-crystal type polyesters include: (I) copolymerized polyesters which are obtained by block copolymerization of two different stiff linear polyesters; (II) polyesters introduced with a non-linear structure, which are obtained by block copolymerization of a rigid linear polyester with a rigid nonlinear polyester; (III) polyesters introduced with a flexible chain, which are obtained by copolymerization of a rigid linear polyester with a flexible polyester; and (IV) nucleus-substituted aromatic polyesters which are obtained by introducing a substituent on the aromatic ring of rigid linear polyesters.

Repeating units of such polyesters include, but are not limited to, (a) those derived from aromatic dicarboxylic acids, (b) those derived from aromatic diols, and (c) aromatic hydroxycarboxylic acids, and these repeating units are as follows:

(a) Repeating units derived from aromatic dicarboxylic acids:

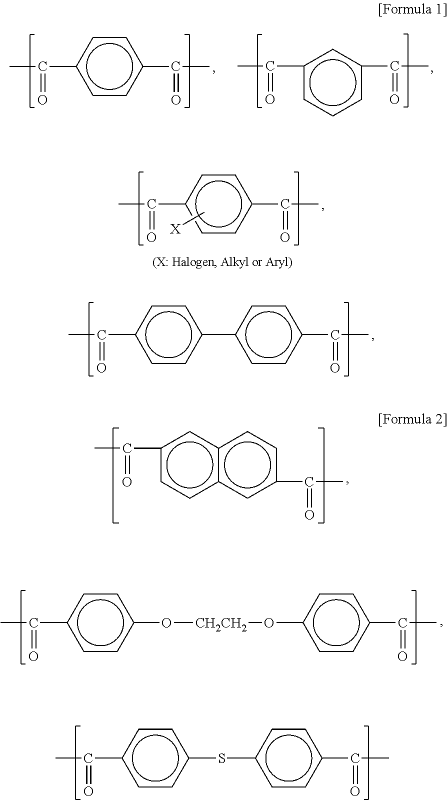

b. Repeating units derived from aromatic diols:

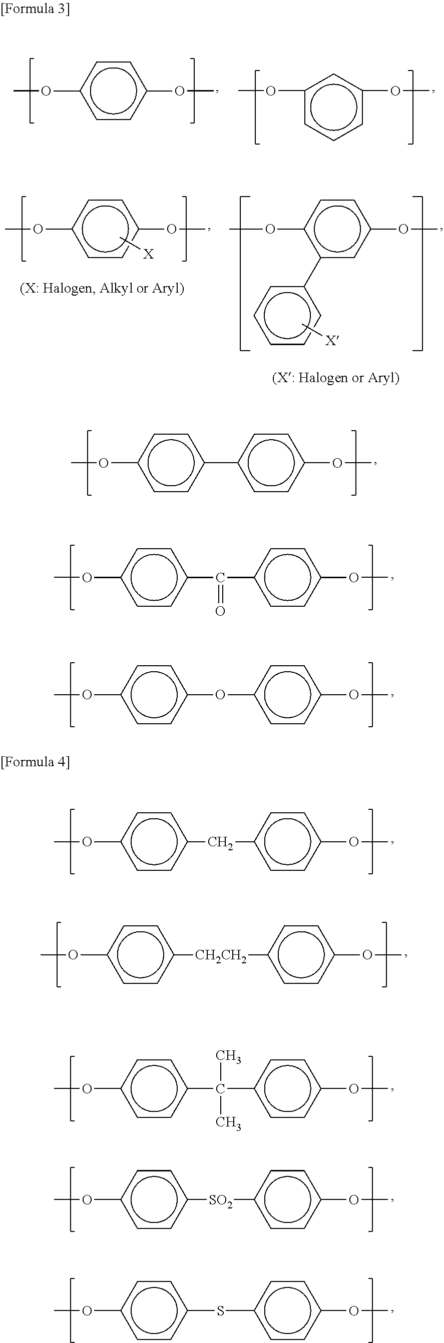

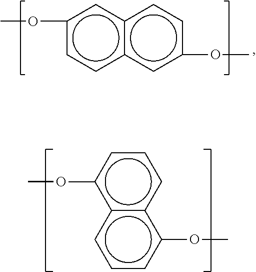

c. Repeating units derived from aromatic hydroxycarboxylic acids:

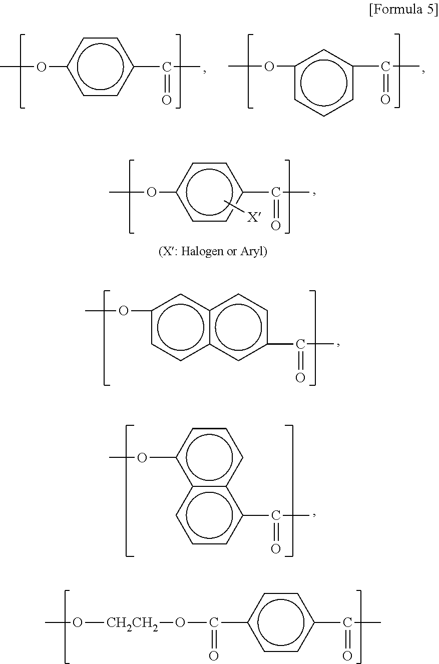

It is preferable from the standpoint of the balance among processability, heat resistance and mechanical properties in film-forming processes that the liquid crystal polymer contains the repeating unit shown in formula 6 below. More preferably, the liquid crystal polymer contains at least 30 mole % (generally less than 80 mole %) of the repeat unit.

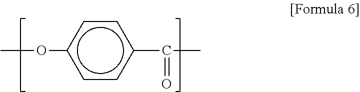

Preferable examples of the combination of repeating units constituting the liquid crystal polymer include the combinations (I) to (IV).

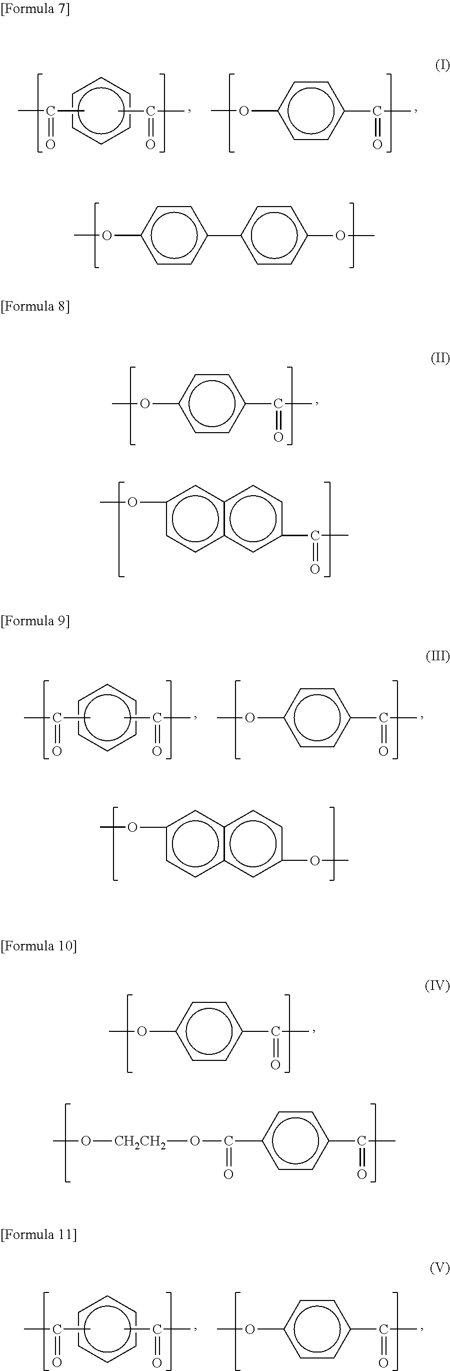

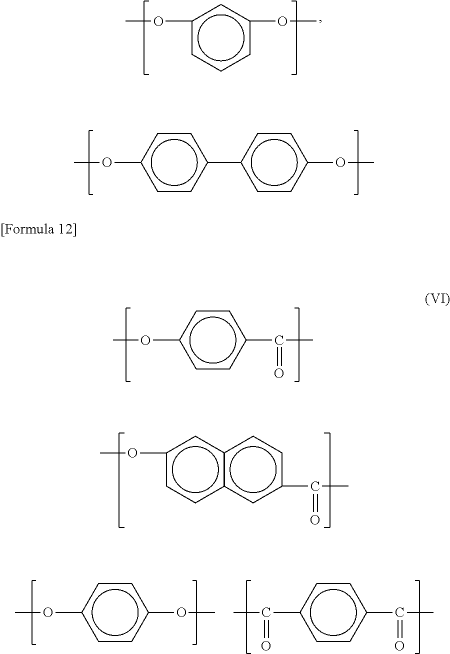

Methods for preparing such liquid-crystal polymers are disclosed in, for example, Japanese Patent Laid-Open Publication No. Hei 2-51523, Japanese Patent Laid-Open Publication No. Sho 63-3888, and Japanese Patent Laid-Open Publication No. Sho 63-3891.

Among them, the combinations shown in (I), (II) and (V) are preferable, and the combination shown in (V) is more preferable.

Because the liquid crystal polymer has a flow temperature of more than 300° C. and a melt viscosity of polyethylene terephthalate or nylon 6,6, it can be extrusion-coated on a substrate at high speed, such that a liquid crystal polymer film can be manufactured at low cost.

The liquid crystal polymer film is characteristic in that the elongation thereof is as extremely low as a few percent, and it has a problem in terms of flexibility. For this reason, according to the present invention, the liquid crystal polymer is blended with a polyester-based resin such as polybutylene terephthalate, polyethylene terephthalate or polyethylene naphthalate so as to improve the elongation of the liquid crystal polymer film, thus improving the flexibility of the film.

In the present invention, the polyester-based resin (A) contains the liquid crystal polymer in an amount of 5-25 parts by mass (preferably 10-20 parts by mass) relative to 75-95 parts by mass (preferably 80-90 parts by mass) of the polyester-based resin other than liquid-crystal polymers. Also, the mixing of the polyester-based resin other than liquid crystal polymers with the liquid crystal polymer may be performed using any conventional method.

(B) Thermoplastic Elastomer

In the present invention, the polyester-based resin composition a thermoplastic elastomer (B) and is preferably a resin dispersion which contains, as a continuous phase, the polyester-based resin (A), and as a dispersed phase, the thermoplastic elastomer (B). In the present invention, the content of the thermoplastic elastomer (B) is preferably less than 15 parts by mass relative to 100 parts by mass of the polyester-based resin (A), and the lower limit of the content of the thermoplastic elastomer (B) is not specifically limited, but is generally more than 4 parts by mass. More preferably, the content of the thermoplastic elastomer (B) is 4-13 parts by mass relative to 100 parts by mass of the polyester-based resin (A).

If the content of the thermoplastic elastomer is too high, heat resistance will be slightly reduced. This is considered to be because the heat resistance of the elastomer is lower than that of either the liquid crystal polymer or the polyester-based resin other than liquid crystal polymers.

Also, the resin dispersion is preferably a resin dispersion which contains, as a continuous phase, the liquid crystal polymer-containing polyester-based resin (A), and as a dispersed phase, the thermoplastic elastomer (B), in which the component (A) has been uniformly finely dispersed in the component (B) by a chemical reaction during melt-kneading of the component (A) with the component (B).

In a preferred embodiment of the present invention, a resin (B-1) containing at least one functional group, which has reactivity with the polyester-based resin and is selected from the group consisting of an epoxy group, an oxazolyl group, an amino group and a maleic anhydride group, is used as the thermoplastic elastomer (B). The resin (B-1) preferably contains an epoxy group. The resin (B-1) preferably contains the functional group-containing component in an amount of 0.05-30 parts by mass, and more preferably 0.1-20 parts by mass, based on 100 parts by mass of all the monomer components. If the amount of the functional group-containing monomer component is excessively small, it is difficult to exhibit the effect of the present invention, and if it is excessively large, it is likely to cause a gelled material due to an overreaction with the polyester-based resin (A).

Such resin (B-1) is preferably a copolymer consisting of an olefin component with an epoxy group-containing compound component. Also, it may be a copolymer consisting of at least one component of an acrylic component and a vinyl component, an olefin component and an epoxy group-containing compound component.

The reactive functional groups of the resin (B-1) substantially completely react with the polyester-based resin, when the resin (B-1) is used for insulated electric wires.

Representative examples of the copolymer (B-1) may include an ethylene/glycidylmethacrylate copolymer, an ethylene/glycidylmethacrylate/methylacrylate terpolymer, an ethylene/glycidylmethacrylate/vinylacetate terpolymer, an ethylene/glycidylmethacrylate/methylacrylate/vinylacetate tetrapolymer, and the like. Among them, the ethylene/glycidylmethacrylate copolymer and the ethylene/glycidylmethacrylate/methylacrylate terpolymer are preferred. Examples of commercially available resin may include Bondfast (trade name, manufactured by Sumitomo Chemical Co., Ltd.) and LOTADER (trade name, manufactured by ATOFINA Chemicals, Inc.).

Moreover, the resin (B-1) may be any of block copolymers, graft copolymers, random copolymers and alternating copolymers. The resin (B-1) may be, for example, a random copolymer of ethylene/propylene, a random copolymer of ethylene/propylene/diene, a block copolymer of ethylene/diene/ethylene, a block copolymer of propylene/diene/propylene, a block copolymer of styrene/diene/ethylene, a block copolymer of styrene/diene/propylene, and a block copolymer of styrene/diene/styrene, partially epoxidated products of a diene component thereto, or graft-modified products of an epoxy-containing compound such as glycidyl methacrylic acid. Also, these copolymers are preferably hydrogenated products of the copolymers in order to enhance heat stability.

In a preferred embodiment of the present invention, a core-shell polymer (B-2), which has a rubber-like core, obtainable from acrylate, methacrylate or a mixture thereof, and an outer shell consisting of a vinyl homopolymer or copolymer, is used as the thermoplastic elastomer (B).

As used herein, the term “core-shell polymer resin (B-2)” refers to a core-shell polymer, which has a rubber-like core, obtainable from acrylate, methacrylate or a mixture thereof (preferably a rubber-like core consisting of an alkylacrylate polymer), and an outer shell consisting of a vinyl polymer or copolymer (preferably an outer shell consisting of a vinyl polymer). In the core-shell polymer resin (B-2) that can be used in the present invention, the core is preferably an acrylic rubber core, which is polymerized from alkyl acrylate having an alkyl group containing 1-6 carbon atoms, has a Tg lower than about 10° C. and contains, in addition to the alkyl acrylate, a crosslinkable monomer and/or a grafting monomer. Preferably, the alkyl acrylate is n-butyl acrylate.

The crosslinkable monomer is a multiethylenically unsaturated monomer, which has a plurality of addition-polymerizable groups, all of which are polymerized at substantially the same reaction rate.

The crosslinkable monomers that are preferably used in the present invention include poly(acrylic ester) and poly(methacrylic ester) of polyol, such as butylene diacrylate or dimethacrylate, trimethylolpropane trimethacrylate and the like, di- and tri-vinylbenzene, vinyl acrylate and methacrylate, and the like. A particularly preferable crosslinkable monomer is butylene diacrylate.

The grafting monomer is a multiethylenically unsaturated monomer, which has a plurality of addition-polymerizable reactive groups, at least one of which is polymerized with another group of the reactive groups at substantially different polymerization rates. The grafting monomer has a function of leaving an unsaturated group in the elastomer phase, specifically on or near the surfaces of the elastomer particles (the rubber-like cores), particularly in a later polymerization step. Therefore, when a stiff thermoplastic shell layer (hereinafter also simply referred to as “shell layer” or “final-step part”) is subsequently formed by polymerization on the surface of the elastomer (the rubber-like core), the addition-polymerizable unsaturated reactive group provided and left by the grafting monomer takes part in the shell layer-forming reaction. As a result, at least a part of the shell layer can be chemically attached to the surface of the elastomer.

Examples of the grafting monomer that is preferably used in the present invention may include alkyl group-containing monomers of allyl esters of ethylenically unsaturated dibasic acids, such as allyl acrylate, allyl methacrylate, diallyl maleate, diallyl fumarate, diallyl itaconate, acidic allyl maleate, acidic allyl fumarate, and acidic allyl itaconate. In particular, the grafting monomer is preferably allyl methacrylate or diallyl maleate.

The outer shell-forming monomer that can be used in the present invention (hereinafter simply referred to as “the monomer for the final-step part” or “the monomer for the shell layer”) is a monomer capable of forming a vinyl-based homopolymer or copolymer. Specific examples of the monomer for the final-step part may include methacrylates, acrylonitrile, alkyl acrylates, alkyl methacrylates, dialkylaminoalkyl methacrylates, and styrene. The above monomers for the final-step part may be used alone or in a mixture of two or more of the above monomers. The monomer for the final-step part is preferably a methacrylate having an alkyl group of 1 to 16 carbon atoms, and most preferably an alkyl methacrylate having an alkyl group of 1 to 4 carbon atoms. The core-shell polymer resin (B-1) is preferably prepared using, but not particularly limited to, an emulsion polymerization method.

One example of the core-shell polymer (B-2) that is preferably used in the present invention, has only two step parts: the first-step part (i.e. rubber-like core) which is a product of polymerization of a monomer system comprising butyl acrylate, as well as butylene diacrylate as a crosslinking agent, and allyl methacrylate or allyl maleate as a grafting agent; and the final-step part (i.e., shell) of a methyl methacrylate polymer. For the purpose of improving the dispersibility in the polyester-resin resin, the shell surface may have at least one functional group selected from the group consisting of an epoxy group, an oxazoline group, an amine group, and a maleic anhydride group.

Commercially available products of the two-step core-shell polymers, as mentioned above, include, but are not limited to, PARALOID EXL-2313, EXL-2314, and EXL-2315 (all registered trademarks) manufactured by Kureha Chemical Industry Co., Ltd.

In another preferred embodiment of the present invention, an ethylene-based copolymer (B-3) having either carboxylic acid or a metal salt of dicarboxylic acid in the side chain thereof is used as the thermoplastic elastomer (B). The ethylene-based copolymer (B-3) functions to inhibit the crystallization of the polyester-based resin.

Examples of the carboxylic acid to be bonded may include unsaturated monocarboxylic acids, such as acrylic acid, methacrylic acid or crotonic acid, and unsaturated dicarboxylic acids, such as maleic acid, fumaric acid or phthalic acid, and examples of the metal salt of carboxylic acid may include Zn, Na, K and Mg salts of carboxylic acid. Examples of such ethylene-based copolymers may include ionomer resins (e.g., trade name Himilan manufactured by Mitsui Polychemicals Co., Ltd.), having a metal salt at part of the carboxylic acid of an ethylene-methacrylic acid copolymer, ethylene-acrylic acid copolymers (e.g., trade name EAA manufactured by Dow Chemical Corp.), and ethylene graft polymers (trade name Adoma manufactured by Mitsui Petrochemical Industries, Ltd.), having carboxylic acid in the side chain thereof.

In the present invention, the insulating layers may contain other heat resistant thermoplastic resins, a thermoplastic elastomer, generally used additives, inorganic filler, a processing aid, a colorant, and the like.

As the conductor for use in the present invention, a metal bare wire (solid wire), an insulated wire having an enamel film or thin insulating layer coated on a metal bare wire, a multicore stranded wire comprising intertwined metal bare wires, or a multicore stranded wire comprising intertwined insulated-wires that each have an enamel film or a thin insulating layer, can be used. The number of the intertwined wires of the multicore stranded wire can be chosen arbitrarily depending on the desired high-frequency application. Alternatively, when the number of wires of a multicore wire is large (e.g., a 19- or 37-element wire), the multicore wire (elemental wire) may be in a form of a stranded wire or a non-stranded wire. In the non-stranded wire, for example, multiple conductors that each may be a bare wire or an insulated wire to form the elemental wire, may be merely gathered (collected) together to bundle up them in an approximately parallel direction, or the bundle of them may be intertwined in a very large pitch. In each case of these, the cross-section thereof is preferably a circle or an approximate circle.

If the insulated electric wire comprises three insulating layers, it is manufactured according to a conventional method by extrusion-coating a first insulating layer around a conductor to a desired thickness and then extrusion-coating a second insulating layer around the first insulating layer. The overall thickness of the extruded insulated layers formed as described is preferably in the range of 60-180 μm in the case of three layers. If the overall thickness of the insulating layers is too small, the electrical properties of the resulting multilayer insulated electric wire are greatly deteriorated and are not suitable for practical use, and if the overall thickness is too large, it is not suitable for miniaturization and makes coil winding difficult. A more preferred thickness range is 70-150 μm. In addition, the thickness of each layer of the three layers is preferably 20-60 μm.

If the insulated electric wire of the present invention is a single-layer insulated electric wire, the insulating layer thereof is composed of the polyester-based resin composition according to the present invention. In addition, if the insulated electric wire of the present invention is a multilayer insulated electric wire having two or three or more layers, all the insulating layers thereof are preferably composed of the polyester-based resin composition according to the present invention.

The insulated electric wire of the present invention sufficiently satisfies a heat resistance level and has excellent solderability, which is required in coil applications, and it is easily treated after coil processing. There has not yet been an insulated electric wire, which has good solderability while maintaining a heat resistance of class F or higher. The insulated electric wire of the present invention can be soldered directly in terminal processing, leading to an improvement in the workability of coil winding. In addition, the use of the insulated electric wire according to the present invention can provide a transformer having excellent electrical properties and high reliability.

### EXAMPLES

Hereinafter, the present invention will be described in further detail with reference to examples, but the scope of the present invention is not limited to these examples.

In the following Examples, a resin composition constituting an insulating layer was prepared by melting and mixing materials in a kneading twin-screw extruder, cooling the extruded material with water, and cutting the cooled material into pellets using a pelletizer. The obtained resin composition of each Example was formed into a film and observed with a transmission electron microscope. As a result, it was observed that the resin compositions of Examples 1 to 8 and Example 10 other than the resin composition of Example 9 containing no thermoplastic elastomer were resin dispersions containing, as a continuous phase, a polyester-based resin, and as a dispersed phase, a thermoplastic elastomer.

### Examples 1 to 10 and Comparative Example 1 to 3

As conductors, annealed copper wires having a, diameter of 0.75 mm were provided. The conductors were extrusion-coated with the extrusion-coating formulations (compositions are shown in terms of parts by mass) and thickness shown in Table 1 below, thus manufacturing single-layer insulated electric wires and multilayer insulated electric wires.

The properties of the manufactured insulated electric wires were measured and evaluated according to the following test methods.

Also, the appearance was visually observed. When cracks or crazes did not appear on the surface, it was judged as “passed” (indicated by the symbol “0” in Table 1), and when these defects appeared, it was judged as “failed” (“X”).

A. Flexibility

An electric wire was closely wound 10 times around itself and observed with a microscope. When cracks or crazes did not appear on the surface, it was judged as “passed” (indicated by the symbol “0” in Table 1), and when these defects appeared, it was judged as “failed” (“X”).

B. Electric heat resistance

An insulated electric wire having a length of about 50 cm was bent into two parts, and about 12-cm portions of the bent parts were twisted 9 times with each other while applying a tension of about 1.5 kg. After removing the tension, the folded portions were cut to prepare twisted samples. The twisted samples were heated at 235 C for 168 hours and measured for breakdown voltage. When the ratio of the residual breakdown voltage after heating was more than 40%, it was judged as “passed” (class F; indicated by the symbol “0” in Table 1), and when the ratio of the residual breakdown voltage was less than 40%, it was judged as “failed” (X). Particularly, those having a residual breakdown voltage of more than 50% and excellent heat resistance were indicated by the symbol “0”.

c. Solvent Resistance

The electric wire subjected to 20D winding was dipped in ethanol or isopropyl alcohol for 30 seconds and dried. Then, the surface of the sample was observed to judge whether crazing occurred or not. In Table 1, the symbol “0” indicates that crazing occurred, and the symbol “X” indicates that no crazing occurred.

D. Solderability

This is a processability test procedure for evaluating solderability after coil processing. The insulated electric wires manufactured by extrusion coating were dipped in flux, and then the 40-mm top was placed in a molten solder at 450 t for 10 seconds. When the spot to which the solder was attached was more than 30 mm, it was judged as “passed” (indicated by the symbol “0” in Table 1), and when it was less than 30 mm, it was judged as “failed” (X).

TABLE 1

| | | | | | | | | | | | | Ex. | Comp. | Comp. | Comp. |
|---|---|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 | 10 | ex. 1 | ex. 2 | ex. 3 |
| First | Polyester | PET | 85 | 85 | 85 | 85 | 75 | 75 | 75 | 75 | 85 | 85 | — | 90 | 70 |
| Layer | based | LCP | 15 | 15 | 15 | 15 | 25 | 25 | 25 | 25 | 5 | 15 | — | — | 30 |
| | resin (A) | | | | | | | | | | | | | | |
| | Thermoplastic | Ethylene copolymer | — | — | 4 | — | — | — | 15 | — | — | — | — | 10 | — |
| | elastomer (B) | Ethylene/glycidyl | 4 | 4 | — | — | 4 | 15 | — | — | — | 17 | — | — | 4 |
| | | methacrylate | | | | | | | | | | | | | |
| | | Core-shell copolymer | — | — | — | 4 | — | — | — | 15 | — | — | — | — | — |
| | PES | | — | — | — | — | — | — | — | — | — | — | 100 | — | — |
| | Layer thickness (μm) | | 33 | 33 | 33 | 33 | 33 | 33 | 33 | 33 | 33 | 33 | 33 | 33 | 33 |
| Second | Polyester | PET | — | 85 | 85 | 85 | 75 | 75 | 75 | 75 | 95 | 85 | — | 90 | 70 |
| Layer | based | LCP | — | 15 | 15 | 15 | 25 | 25 | 25 | 25 | 5 | 15 | — | — | 30 |
| | resin (A) | | | | | | | | | | | | | | |
| | Thermoplastic | Ethylene copolymer | — | — | 4 | — | — | — | 15 | — | — | — | — | 10 | — |
| | elastomer (B) | Ethylene/glycidyl | — | 4 | — | — | 4 | 15 | — | — | — | 17 | — | — | 4 |
| | | methacrylate/methyl | | | | | | | | | | | | | |
| | | acrylate terpolymer | | | | | | | | | | | | | |
| | | Core-shell copolymer | — | — | — | 4 | — | — | — | 15 | — | — | — | — | — |
| | PES | | — | — | — | — | — | — | — | — | — | — | 100 | — | — |
| | Layer thickness (μm) | | — | 33 | 33 | 33 | 33 | 33 | 33 | 33 | 33 | 33 | 33 | 33 | 33 |
| Third | Polyester | PET | — | 85 | 85 | 85 | 75 | 75 | 75 | 75 | 95 | 85 | — | — | 70 |
| Layer | based | LCP | — | 15 | 15 | 15 | 25 | 25 | 25 | 25 | 5 | 15 | — | — | 30 |
| | resin (A) | | | | | | | | | | | | | | |
| | Thermoplastic | Ethylene copolymer | — | — | 4 | — | — | — | 15 | — | — | — | — | — | — |
| | elastomer (B) | ethylene/glycidyl | — | 4 | — | — | 4 | 15 | — | — | — | 17 | — | — | 4 |
| | | methacrylate/methyl | | | | | | | | | | | | | |
| | | acrylate terpolymer | | | | | | | | | | | | | |
| | | core-shell copolymer | — | — | — | 4 | — | — | — | 15 | — | — | — | — | — |
| | PES | | — | — | — | — | — | — | — | — | — | — | 100 | — | — |
| | Ny66 | | — | — | — | — | — | — | — | — | — | 33 | — | 100 | — |

| | | | | | | | | | | | | | |
|---|---|---|---|---|---|---|---|---|---|---|---|---|---|
| Layer thickness (μm) | — | 33 | 33 | 33 | 33 | 33 | 33 | 33 | 33 | 33 | 33 | 33 | 33 |

| Total Layer thickness (μm) | | 33 | 100 | 100 | 100 | 100 | 100 | 100 | 100 | 100 | 100 | 100 | 100 | 100 |
|---|---|---|---|---|---|---|---|---|---|---|---|---|---|---|
| Appearance | | ◯ | ◯ | ◯ | ◯ | ◯ | ◯ | ◯ | ◯ | ◯ | ◯ | ◯ | ◯ | ◯ |
| Flexibility | | ◯ | ◯ | ◯ | ◯ | ◯ | ◯ | ◯ | ◯ | ◯ | ◯ | ◯ | ◯ | X |
| Electric heat resistance | | ⊚ | ⊚ | ⊚ | ⊚ | ⊚ | ⊚ | ⊚ | ⊚ | ⊚ | ◯ | ⊚ | X | ⊚ |
| Crazing occurred or | Ethanol | ◯ | ◯ | ◯ | ◯ | ◯ | ◯ | ◯ | ◯ | ◯ | ◯ | X | ◯ | ◯ |
| not after solvent | Isopropyl alcohol | ◯ | ◯ | ◯ | ◯ | ◯ | ◯ | ◯ | ◯ | ◯ | ◯ | X | ◯ | ◯ |
| dipping | | | | | | | | | | | | | | |
| Solderability | | ◯ | ◯ | ◯ | ◯ | ◯ | ◯ | ◯ | ◯ | ◯ | ◯ | X | ◯ | ◯ |
| Passed or Failed | | ◯ | ◯ | ◯ | ◯ | ◯ | ◯ | ◯ | ◯ | ◯ | ◯ | X | X | X |

In Table 1, the symbol “−” indicates that no component or ingredient was added to the composition of resins. Also, the symbol “O” indicates preferred, and “x” indicates not suitable.

In Table 1, the abbreviations representing the respective resins to be used are as follows:

PET: Teijin PET (trade name, manufactured by Teijin Ltd.) polyethylene terephthalate resin;

Ethylene-based copolymer: Himilan 1855 (trade name, manufactured by Mitsui-Dupont Co., Ltd.) ionomer resin;

Core-shell copolymer: core-shell copolymer PARALOID EXL2313 (trade name, manufactured by Kureha Chemical Industry Co., Ltd.) having a rubber-like core, obtained from acrylic resin, and an outer shell consisting of a vinyl homopolymer;

LCP: liquid-crystal polymer, Rodrun LC5000 (trade name, manufactured by Unitika Co., Ltd.);

PES: polyethersulfone resin, Sumika Excel PES 4100 (trade name, manufactured by Sumitomo Chemical Co., Ltd.);

Ny66: nylon 66, FDK-1 (trade name, manufactured by Unitika Co., Ltd.).

Also, the conductor was covered sequentially with a first layer, a second layer and a third layer, and in the case of the three-layer structure, the third layer was the outermost layer.

The results shown in Table 1 revealed the following.

The insulated electric wire of Comparative Example 1 which is a three-layer insulated electric wire comprising only PES in the insulating layers without LCP had insufficient solvent resistance and solderability. The insulated electric wire of Comparative Example 2 comprising PET/ionomer and nylon 66 in the insulating layers without LCP had insufficient electrical heat resistance. Also, the electric wire of Comparative Example 3 comprising an excessive amount of LCP had insufficient flexibility.

In comparison with this, in Example 9, the appearance, flexibility, electrical heat resistance, solvent resistance and solderability of the electric wire were all excellent. In addition, the insulated electric wire of Example 10, which is an insulated electric wire covered with a polyester-based resin composition containing the thermoplastic elastomer in an amount of 17 parts by mass to 100 parts by mass of the polyester-based resin, had heat resistance inferior to those of Examples 1 to 9, but was a passed product belonging to the class F.

### INDUSTRIAL APPLICABILITY

The insulated electric wire of the present invention has at least one insulating layer, and preferably at least three insulating layers.

Having described our invention as related to the present embodiments, it is our intention that the invention not be limited by any of the details of the description, unless otherwise specified, but rather be construed broadly within its spirit and scope as set out in the accompanying claims.

1.-6. (canceled)

7. An insulated electric wire having a conductor and one or more insulating layers covering the conductor, the insulated electric wire comprising a polyester-based resin composition which constitutes at least one layer of the insulating layers and comprises a polyester-based resin (A) containing a liquid crystal polymer in an amount of 5-25 parts by mass relative to 75-95 parts by mass of a polyester-based resin other than liquid crystal polymers.

8. The insulated electric wire according to claim 7, wherein the polyester-based resin composition comprises a thermoplastic elastomer (B) and is a resin dispersion which contains, as a continuous phase, the polyester-based resin (A), and as a dispersed phase, the thermoplastic elastomer (B).

9. The insulated electric wire according to claim 8, wherein a resin (B-1) containing at least one functional group selected from the group consisting of an epoxy group, an oxazolyl group, an amino group and a maleic anhydride group is used as the thermoplastic elastomer (B).

10. The insulated electric wire according to claim 8, wherein a core-shell polymer (B-2) having a rubber-like core, obtained from acrylate, methacrylate or a mixture thereof, and an outer shell consisting of a vinyl homopolymer or copolymer, is used as the thermoplastic elastomer (B).

11. The insulated electric wire according to claim 8, wherein an ethylene-based copolymer (B-3) having either carboxylic acid or a metal salt of dicarboxylic acid in the side chain thereof is used as the thermoplastic elastomer (B).

12. The insulated electric wire according to claim 8, wherein the polyester-based resin composition contains the thermoplastic elastomer (B) in an amount of less than 15 parts by mass relative to 100 parts by mass of the polyester-based resin (A).

13. The insulated electric wire according to claim 12, wherein a resin (B-1) containing at least one functional group selected from the group consisting of an epoxy group, an oxazolyl group, an amino group and a maleic anhydride group is used as the thermoplastic elastomer (B).

14. The insulated electric wire according to claim 12, wherein a core-shell polymer (B-2) having a rubber-like core, obtained from acrylate, methacrylate or a mixture thereof, and an outer shell consisting of a vinyl homopolymer or copolymer, is used as the thermoplastic elastomer (B).

15. The insulated electric wire according to claim 12, wherein an ethylene-based copolymer (B-3) having either carboxylic acid or a metal salt of dicarboxylic acid in the side chain thereof is used as the thermoplastic elastomer (B).
